(19) United States
(12) Patent Application Publication
(10) Pub. No.: US 2025/0074924 A1
(43) Pub. Date: Mar. 6, 2025

(54) BIMETAL-ORGANIC FRAMEWORK FOR ABSORBING CARBON DIOXIDE AND METHOD FOR PRODUCING THE SAME

(71) Applicant: CHANGWON NATIONAL UNIVERSITY INDUSTRY ACADEMY COOPERATION CORPS, Changwon-si, Gyeongsangnam-do (KR)

(72) Inventors: Sang Il Han, Haeundae-Gu, Busan (KR); Ranjit Gaikwad, Uichang-Gu, Changwon-Si (KR)

(73) Assignee: CHANGWON NATIONAL UNIVERSITY INDUSTRY ACADEMY COOPERATION CORPS, Changwon-si, Gyeongsangnam-do (KR)

(21) Appl. No.: 18/285,177

(22) PCT Filed: Sep. 21, 2022
(86) PCT No.: PCT/KR2022/014119

§ 371 Date: Sep. 29, 2023

(30) Foreign Application Priority Data
Jun. 14, 2022 (KR) 10-2022-0072311

(51) Int. Cl. C07F 3/06; B01J 20/22

(52) U.S. Cl. CPC C07F 3/06; B01J 20/226

(57) ABSTRACT

The present disclosure relates to a method for preparing a bimetal-organic framework including preparing a first mixture by mixing, in a solvent, a first metal precursor including zinc, a coordination compound of organic acid, and a substance including a counterion of the coordination compound; preparing a second mixture by mixing, in the first mixture, a second metal precursor including at least one metal selected from a group of magnesium, manganese, and copper, and irradiating the second mixture with the microwave.

### TECHNICAL FIELD

The following disclosure relates to a bimetal-organic framework for absorbing carbon dioxide and a method for preparing the same.

### BACKGROUND ART

Carbon dioxide (CO₂) causes global warming and extreme weather events. Approximately 45% of the CO₂ in the atmosphere is emitted from various industries, such as thermal power plants, cement production, and iron and steel manufacturing. The concentration of atmospheric CO₂ has risen from 280 ppm in the early 1800s to over 400 ppm in 2018. Recent studies predict that the CO₂ level could reach a minimum of 550 ppm by 2050 and 950 ppm by 2100. There is a global effort to use non-carbon energy sources and reduce the use of fossil fuels in order to control atmospheric CO₂ levels. However, the current energy generation technologies based on fossil fuels are still being utilized. Therefore, CO₂ capture and sequestration (CCS) is considered one of the promising technologies among others to control the concentration of atmospheric CO₂.

In recent years, many technologies have been established for CO₂ capture, including physical adsorption, chemical absorption, cryogenic distillation, and membrane separation. Among these, chemical absorption is commonly used for CO₂ capture, and it is accomplished using amine solutions due to their ease operation. However, the chemical absorption method has several issues, such as toxicity, solution losses, equipment corrosion, and the significant energy required for regeneration. Therefore, the challenge is to develop promising adsorbents with high CO₂ capacity and selectivity, competitive production costs, and low environmental impact.

In an effort to address the challenge, solid adsorbents such as activated carbon, zeolites, mesoporous silica, covalent organic frameworks (COFs), and metal-organic frameworks (MOFs) have been employed as CO₂ adsorbents.

Among them, metal-organic frameworks are nanoparticles with very well-defined pore sizes, high surface areas and pore volumes, and rigid structures. In addition, the pore size and chemical environment in the pores can be easily controlled by selecting suitable organic ligands, i.e., two-digit compounds, and they have the characteristics of excellent heat and chemical resistance. Porous metal-organic frameworks are composed of metal oxide aggregates and organic linking groups, and the coordination structures formed from these metal ionic parts and organic ligands can form not only simple molecular forms through self-assembly, but also various framework structures ranging from linear primary, plate-like secondary, to complex three-dimensional structures. A general synthesis method is solvothermal synthesis, in which the precursors of each component are dissolved in appropriate concentrations using polar solvents and heated in a sealed container, and the synthesis occurs under self-generated pressure.

However, such synthesis methods usually require several days or more of reaction time due to slow nucleation and crystallization processes, resulting in excessive energy consumption and very low efficiency in obtaining fully crystalline MOF compounds. Moreover, the existing inefficient synthesis methods for porous MOFs have been pointed out as a barrier to industrial applications, primarily due to their high manufacturing costs. Furthermore, these conventional synthesis methods have inherent limitations in surface area and adsorption capacity, making industrial applications problematic.

### DISCLOSURE

### Technical Problem

The purpose of the present disclosure is to provide a bimetal-organic framework having improved CO₂ adsorption capacity and CO₂/N₂ selectivity compared to conventional metal organic frameworks and enhanced stability in a use environment and a method for preparing the same.

### Solution to Problem

The present disclosure relates to a method for preparing a bimetal-organic framework, including: preparing a first mixture by mixing a first metal precursor including zinc, a coordination compound of organic acid, and a substance including a counterion of the coordination compound in a solvent; preparing a second mixture by mixing a second metal precursor including at least one metal selected from a group of magnesium, manganese, and copper in the first mixture; and irradiating microwave to the second mixture.

The organic acid may be selected from a group of citric acid, pyridine dicarboxylic acid, methyl fumarate, dihydroxyterephthalic acid, hydroxyterephthalic acid, ammonium citrate, and combinations thereof, but is not limited thereto.

The counterion may be selected from a group of K⁺, Na⁺, Li⁺, H⁺, Rb⁺, Cs⁺, and combinations thereof, but is not limited thereto.

The first metal precursor may be included at 70 wt % with respect to 100 wt % of the bimetal-organic framework.

The second metal precursor may be included at 10 wt % to 30 wt % with respect to 100 wt % of the bimetal-organic framework.

The first mixture may include Zn(CH₃COO)₂·2H₂O, C₆H₈O₇·H₂O, and KOH.

The solvent is selected from a group of water, ethanol, methanol, ethyl ether, toluene, acetone, isopropyl alcohol, benzene, xylene, N-methylpyrrolidone, tetrahydrofuran, nitrobenzene, N,N-dimethylformamide, dimethyl sulfoxide, diethyl carbonate, benzyl acetate, dimethyl glutarate, ethyl acetoacetate, isobutyl isobutanoate, isobutyl acetate, m-Cresol, and combinations thereof, but is not limited thereto.

The irradiating of the microwave to the second mixture may be conducted for 2 hours to 8 hours.

The microwave may be irradiated with a power of 100 W to 300 W.

The irradiating of the microwave to the second mixture is conducted at temperature of 50° C. to 150° C.

Additionally, the present disclosure relates to a bimetal-organic framework including: zinc; and at least one metal selected from a group of magnesium, manganese, and copper, and the bimetal-organic framework adsorbs carbon dioxide.

The bimetal-organic framework may be UTSA-16 (Zn, Mg), UTSA-16 (Zn, Mn), or UTSA-16 (Zn, Cu).

CO₂/N₂ adsorption selectivity of the bimetal-organic framework may be 120 to 150.

Pore volume of the bimetal-organic framework may be 0.9 cm³/g to 1.5 cm³/g.

### Effects of Invention

The bimetal-organic framework according to the present disclosure allows for having improved CO₂ adsorption capacity and CO₂/N₂ adsorption selectivity than conventional metal-organic frameworks due to the dual introduction of metals.

Moreover, the bimetal-organic framework according to the present disclosure exhibits stable crystal structure, adsorption, and selectivity even when exposed to moisture, acid, etc.

### BRIEF DESCRIPTION OF DRAWINGS

FIG. 1 illustrates a flowchart showing each step of a method for preparing a bimetal-organic framework.

FIG. 2 illustrates Scanning Electron Microscopy (SEM) images of a bimetal-organic framework prepared according to an embodiment of the present disclosure. Specifically, (a) of FIG. 2 shows Embodiment 2 (additive ratio Zn:Mg=7:2), (b) of FIG. 2 shows Embodiment 5 (additive ratio Zn:Mn=7:2), and (c) of FIG. 2 shows Embodiment 8 (additive ratio Zn:Cu=7:2).

FIG. 3 illustrates a graph of the CO₂ adsorption capacity of the bimetal-organic framework prepared according to an embodiment of the present disclosure according to the additive ratio of a second metal. Specifically, (a) of FIG. 3 corresponds to Embodiments 1 to 3, (b) of FIG. 3 corresponds to Embodiments 4 to 6, and (c) of FIG. 3 corresponds to Embodiments 7 to 9.

FIG. 4 illustrates a graph of the CO₂/N₂ adsorption selectivity according to the weight percent of the second metal (Mg, Mn, or Cu) of a bimetal-organic framework prepared according to an embodiment of the present disclosure.

FIG. 5 illustrates a graph of the CO₂ adsorption capacity of the bimetal-organic framework prepared according to an embodiment of the present disclosure after exposure to harsh conditions (humid air, NO₂ gas. and SO₂ gas).

### BEST MODE FOR CARRYING OUT THE INVENTION

The disclosure can have various changes and can have various embodiments, so specific embodiments are illustrated in the drawings and will be described in detail in the detailed description. However, this is not intended to limit the following disclosure to a specific embodiment, it should be understood to include all modifications, equivalents and substitutes included in the spirit and scope of the disclosure.

Throughout the present specification, when a part “comprise,” “include,” and “has” a component, this means that other components may be further included rather than excluding the other components unless there is a specific contrary description.

As used herein, the terms “about,” “substantially,” etc., to the extent used herein, are used in or close to the numerical value when the manufacturing and material tolerances inherent in the stated meaning are presented, and to aid in the understanding of the present application. It is used to prevent an unconscionable infringer from using the mentioned disclosure unfairly. Also, throughout this specification, “step to” or “step of” does not mean “step for”.

Those of ordinary skill in the technical field of this invention can apply various applications through the gist of this invention, and thus the scope of this invention is not limited to the following embodiments.

Based on the matters described in the scope of claims, the scope of the present invention extends to a part where it is obvious that a person with ordinary knowledge belonging to the technical field of the present invention easily replaces or changes using conventional technology.

Hereinafter, the present disclosure is described in more detail with reference to the accompanying drawings.

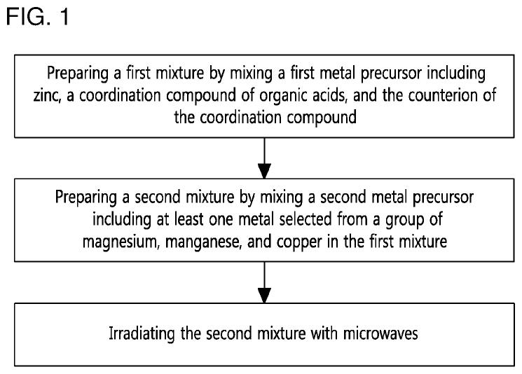

FIG. 1 illustrates a flowchart showing each step of a method for preparing a bimetal-organic framework.

A method for preparing a bimetal-organic framework as illustrated in FIG. 1 includes preparing a first mixture by mixing, in a solvent, a first metal precursor including zinc, a coordination compound of organic acid, and a substance including a counterion of the coordination compound; preparing a second metal precursor by mixing, in the first mixture, a second metal precursor including at least one metal selected from a group of magnesium, manganese, and copper; and irradiating the second mixture with microwave.

In the following, a method for preparing a bimetal-organic framework according to the present disclosure will be described in detail for each step.

The method for preparing a bimetal-organic framework according to the present disclosure includes preparing a first mixture by mixing a first metal precursor including zinc, a coordination compound of organic acid, and a substance including a counterion of the coordination compound in a solvent.

The metal-organic framework (MOF) is a porous material in which metal ions or metal-containing clusters are connected by organic ligands, and is considered as a type of coordination polymer. The MOF forms a three-dimensional structure, maintaining both porosity and strong bonds, and performs various functions such as gas storage, catalysis, drug delivery, chemical sensing, etc.

The first metal precursor including the zinc may be any one selected from a group of zinc nitrate, zinc sulfate, zinc chloride, zinc acetate, zinc acetylacetonate, zinc hexamine chloride, and combinations thereof, but is not limited thereto. Any metal precursor may be used as long as it includes zinc ions and can facilitate zinc incorporation into the metal organic framework of the present disclosure.

The organic acid may be selected from a group of citric acid, pyridine dicarboxylic acid, methyl fumaric acid, dihydroxyterephthalic acid, hydroxyterephthalic acid, ammonium citrate, and combinations thereof, but is not limited thereto.

The counterion may be selected from a group of K⁺, Na⁺, Li⁺, H⁺, Rb⁺, Cs⁺ and combinations thereof, but is not limited thereto.

The counterion may be generated by a solution of KOH, K2SO4, KCl, KBr, KI, KF, NaOH, NaCl, NaBr, Nal, NaF, LiOH, LiCl, LiBr, Lil, LiF, HCl, HBr, HI, HF, RbOH, RbCl, RbBr, RbI, RbF, CsOH, CsCl, CsBr, CsI, CsF, and combinations thereof, but is not limited thereto.

The present disclosure also includes preparing a second mixture by mixing, in the first mixture, a second metal precursor including at least one metal selected from a group of magnesium, manganese, and copper.

The second metal precursor may be any one selected from a group of magnesium nitrate, magnesium sulfate, magnesium chloride, magnesium acetate, magnesium acetylacetonate, magnesium hexamine chloride, manganese nitrate, manganese sulfate, manganese chloride, manganese acetate, manganese acetylacetonate, manganese hexamine chloride, copper nitrate, copper sulfate, copper chloride, copper acetate, copper acetylacetonate, copper hexamine chloride, and combinations thereof, but is not limited thereto. Any metal precursor that contains magnesium, manganese, or copper ions and that can facilitate the introduction of magnesium, manganese, or copper into the metal-organic framework of the present disclosure may be employed.

With respect to 100 wt % of the bimetal-organic framework, the first metal precursor may be included at 70 wt %.

With respect to 100 wt % of the bimetal-organic framework, the second metal precursor may be included in the range of 10 wt % to 30 wt %, and more preferably 20 wt %. If the second metal precursor is included in less than 10 wt %, it results in an insufficient introduction of the second metal, leading to a decrease in the surface area and pore volume of the bimetal-organic framework. On the other hand, if the second metal precursor is included in more than 30 wt %, it results in an excessive introduction of the second metal, leading to a decrease in the surfaced area of the metal-organic framework. Therefore, when the second metal precursor is in the range of 10 wt % to 30 wt % with respect to 100 wt % of the bimetal-organic framework of the present disclosure, an improved CO₂ adsorption capacity may be obtained without causing a decrease in the surface area and pore volume of the metal-organic framework. Specific details related to this will be described in the following {Embodiment and evaluation}.

The first mixture may include Zn(CH₃COO)²·2H₂O, C₆H₈O₇·H₂O and KOH.

The solvent may be selected from a group of water, ethanol, methanol, ethyl ether, toluene, acetone, isopropyl alcohol, benzene, xylene, N-methylpyrrolidone, tetrahydrofuran, nitrobenzene, N,N-dimethylformamide, dimethyl sulfoxide, diethyl carbonate, benzyl acetate, dimethyl glutarate, ethyl acetoacetate, isobutyl isobutanoate, isobutyl acetate, m-Cresol, and combinations thereof, but is not limited thereto. Any solvent that facilitates dissolution of the first metal precursor, second metal precursor, organic acid, counterion, etc. can be used.

The present disclosure further includes irradiating the second mixture with microwave.

The time for irradiating microwave may be 2 to 8 hours, and more preferably 4 to 6 hours. If the time for irradiating microwave is less than 2 hours, there may be an issue of insufficient formation of crystals of the bimetal-organic framework. On the other hand, if it exceeds 8 hours, there may be an issue where the metal ion clusters of the first and second metal precursors within the mixture compete with the organic ligands within the coordination compound, leading to a decrease in crystallinity. Therefore, when the time for irradiating microwave to the second mixture is 2 hours to 8 hours, the crystal formation of the bimetal-organic framework of the present disclosure is not degraded, and sufficient crystals for carbon dioxide adsorption may be generated.

The irradiation power of the microwave may be in the range of 100 to 300 W. If the microwave irradiation power is less than 100 W, there may be an issue where the crystallinity of the bimetal-organic framework deteriorates. On the other hand, if the microwave irradiation power exceeds 300 W, there may be an issue where dissociation of the bimetal-organic framework occurs. Therefore, when the microwave irradiation power is in the range of 100 to 300 W, the bimetal-organic framework does not dissociate and sufficient crystals for carbon dioxide adsorption may be generated.

When irradiating the microwave, the temperature may be in the range of 50 to 150° C., and preferably from 80 to 120° C. If the temperature is below 50° C., there may be an issue where it is hard for crystals of the bimetal-organic framework to be generated due to low temperature. On the other hand, if the temperature exceeds 150° C., there may be an issue where the organic framework may be carbonized, leading to a decrease in the formation of the crystals of the metal-organic framework. Therefore, setting the temperature for irradiating the microwave in the range of 50 to 150° C. allows for the generation of adequately crystallized bimetal-organic frameworks for carbon dioxide adsorption.

In addition, to solve the aforementioned issues, the present disclosure describes a bimetal-organic framework that includes zinc; and at least one metal selected from a group of magnesium, manganese, and copper and that adsorbs carbon dioxide.

The bimetal-organic framework may be UTSA-16 (Zn, Mg), UTSA-16 (Zn, Mn), or UTSA-16 (Zn, Cu).

The CO₂/N₂ adsorption selectivity of the bimetal-organic framework may be 120 to 150.

The pore volume of the bimetal-organic framework may be from 0.9 cm³/g to 1.5 cm³/g.

The specific details of the CO₂/N₂ adsorption selectivity and pore volume of the bimetal-organic framework described above will be described in the following {Embodiment and evaluation}.

### MODE(S) FOR CARRYING OUT THE INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness, noting that omissions of features and their descriptions are also not intended to be admissions of their general knowledge.

### EMBODIMENT AND EVALUATION

### 1. Test Equipment

The following equipment was used to analyze and evaluate each embodiment and comparative example:
Scanning electron microscopy (SEM)
Energy dispersive X-ray spectroscopy (EDS)
Brunauer-Emmett-Teller (BET) analysis

### 2. Experiment

### Preparation of First Mixture

Zn(CH₃COO)₂·2H₂O (1.5365 g, 7 mmol), C₆H₈O₇·H₂O (1.47 g, 7 mmol), and KOH (1.17 g, 21 mmol) were dissolved in 35 ml of the H₂O:C₂H₅OH=1:1 v/v solvent.

### Preparation of Bimetal-Organic Framework

### Embodiment 1

To the first mixture, which was prepared as described above, 1 mmol of (CH₃COO)₂Mg·4H₂O was added. The mixture was sealed with a Teflon cap and heated at 90° C., 18 bar, and 300 W of microwave irradiation for 4 hours in a microwave oven (Discover SP, CEM, USA). The formed precipitate was washed twice with diethyl ether, then thrice with methanol, and finally soaked in methanol for three days for solvent exchange. Soaking in methanol was repeated thrice per day. Finally, the formed metal organic framework was separated by centrifugation at 5000 rpm and dried in vacuum for 2 hours, followed by heating at 90° C. for 6 hours in vacuum to remove excess solvent.

### Embodiment 2

Embodiment 2 was conducted in the same way as Embodiment 1 to prepare a bimetal-organic framework, except that 2 mmol of (CH₃COO)₂Mg·4H₂O was added to the first mixture prepared as described above.

### Embodiment 3

Embodiment 3 was conducted in the same way as Embodiment 1 to prepare a bimetal-organic framework, except that 3 mmol of (CH₃COO)₂Mg·4H₂O was added to the first mixture prepared as described above.

### Embodiment 4

Embodiment 4 was conducted in the same way as Embodiment 1 to prepare a bimetal-organic framework, except that 1 mmol of (CH₃COO)₂Mn·4H₂O was added to the first mixture prepared as described above.

### Embodiment 5

Embodiment 5 was conducted in the same way as Embodiment 1 to prepare a bimetal-organic framework, except that 2 mmol of (CH₃COO)₂Mn·4H₂O was added to the first mixture prepared as described above.

### Embodiment 6

Embodiment 6 was conducted in the same way as Embodiment 1 to prepare a bimetal-organic framework, except that 3 mmol of (CH₃COO)₂Mn·4H₂O was added to the first mixture prepared as described above.

### Embodiment 7

Embodiment 7 was conducted in the same way as Embodiment 1 to prepare a bimetal-organic framework, except that 1 mmol of (CH₃COO)₂Cu was added to the first mixture prepared as described above.

### Embodiment 8

Embodiment 8 was conducted in the same way as Embodiment 1 to prepare a bimetal-organic framework, except that 2 mmol of (CH₃COO)₂Cu was added to the first mixture prepared as described above.

### Embodiment 9

Embodiment 9 was conducted in the same way as Embodiment 1, except that 3 mmol of (CH₃COO)₂Cu was added to the first mixture prepared as described above.

### Comparative Example 1

The first mixture, which was prepared as described above, was sealed with a Teflon cap and heated at 90° C. and 300 W of microwave irradiation for 4 hours in a microwave oven (Discover SP, CEM, USA). The formed precipitate was washed twice with diethyl ether, then thrice with methanol, and finally soaked in methanol for three days for solvent exchange. Soaking in methanol was repeated thrice per day. Finally, the formed metal organic framework was separated by centrifugation at 5000 rpm and dried in vacuum for 2 hours, followed by heating at 90° C. for 6 hours in vacuum to remove excess solvent.

The SEM, EDS measurement, and BET analysis were conducted on Embodiments 1 to 9 and Comparative Example 1.

### Stability in Harsh Conditions

### Embodiment 10

A binder solution of 4% was prepared by dissolving PVB in 20 g of ethanol. A desired amount of the bimetal-organic framework prepared according to Embodiment 2 was mixed in 0.4 ml of the 4% binder solution. The resulting mixture was pelletized using a pelletizer and dried at 100° C. in vacuum for 12 hours and then a bimetal-organic framework was prepared.

### Experimental Example 1

The bimetal-organic framework prepared according to Embodiment 10 was exposed to 80% relative humidity at room temperature for two days.

### Experimental Example 2

The bimetal-organic framework prepared according to Embodiment 10 was placed in a chamber with 10 ppm NO₂ and then exposed to NO₂ gas at room temperature for two days.

### Experimental Example 3

The bimetal-organic framework prepared according to Embodiment 10 was placed in a chamber with 15 ppm of SO₂ and then exposed to SO₂ gas at room temperature for two days.

The BET analysis was performed on the bimetal-organic frameworks of Embodiment 10 and Experimental Examples 1 to 3.

### 3. Evaluation

### Preparation of Bimetal-Organic Framework

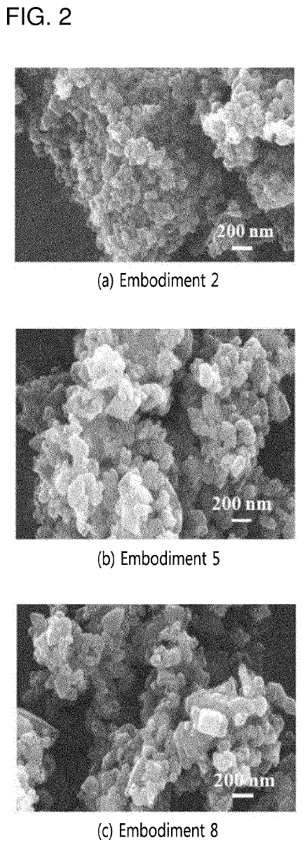

FIG. 2 illustrates SEM images of a bimetal-organic framework prepared according to an embodiment of the present disclosure. Specifically, (a) of FIG. 2 shows Embodiment 2, (b) of FIG. 2 shows Embodiment 5, and (c) of FIG. 2 shows Embodiment 8.

Referring to FIG. 2, crystalline morphology of a bimetal-organic framework prepared according to the preparation method of the present disclosure can be seen.

TABLE 1

| | Atomic ratio (%) | | | | |
|---|---|---|---|---|---|
| | | | | X (X = Mg, | |
| | C | O | K | Mn, or Cu) | Zn |
| Embodiment 2 | 48.06 | 36.98 | 4.71 | 1.62 | 8.63 |
| Embodiment 5 | 47.57 | 38.19 | 4.45 | 1.42 | 8.37 |
| Embodiment 8 | 50.48 | 35.26 | 4.51 | 1.2 | 8.55 |
| Comparative | 50.12 | 35.19 | 4.62 | — | 10.07 |
| Example 1 | | | | | |

Table 1 above is a table showing the results of performing EDS elemental analysis for Embodiments 2, 5, 8 and Comparative Example 1.

Referring to Table 1, it can be seen that the elements of Mg, Mn, or Cu are introduced into the bimetal-organic framework prepared according to the preparation method of the present disclosure.

TABLE 2

| | BET surface area | Pore volume |
|---|---|---|
| | (m²/g) | (cm³/g) |
| Embodiment 1 | 792.27 | 1.010 |
| Embodiment 2 | 825.19 | 1.020 |
| Embodiment 3 | 772.26 | 0.969 |
| Embodiment 4 | 790.54 | 1.076 |
| Embodiment 5 | 810.43 | 1.462 |
| Embodiment 6 | 758.51 | 0.923 |
| Embodiment 7 | 797.16 | 1139 |
| Embodiment 8 | 817.40 | 1.201 |
| Embodiment 9 | 766.60 | 1.063 |
| Comparative Example 1 | 786.61 | 0.787 |

Table 2 is a table showing the BET surface area and pore volume of Embodiments 1 to 9 and Comparative Example 1. Referring to Table 2, it can be seen that Embodiments 1, 2, 4, 5, 7, and 8 show improved BET surface area compared to Comparative Example 1, and Embodiments 1 to 9 show improved pore volume compared to Comparative Example 1.

Furthermore, referring to Table 2 above, it can be seen that the largest BET surface area and pore volume are obtained when the addition ratio of the first metal (Zn) to the second metal (Mg, Mn, and Cu) is 7:2 (Embodiments 2, 5, and 8). It means that with the additional introduction of second metal into the metal-organic framework, the surface area and pore volume of the metal-organic framework increased due to the additional open metal sites.

TABLE 3

| | CO₂ adsorption | CO₂/N₂ adsorption |
|---|---|---|
| | capacities (mmol/g) | selectivity |
| Embodiment 2 | 5.56 | 141 |
| Embodiment 5 | 5.28 | 135 |
| Embodiment 8 | 5.13 | 131 |
| Comparative Example 1 | 5.02 | 105 |

Table 3 is a table showing the CO₂ adsorption capacity and CO₂/N₂ adsorption selectivity according to Embodiments 2, 5, 8, and Comparative Example 1.

Referring to Table 3, it can be seen that bimetal-organic frameworks prepared according to Embodiments 2, 5, and 8 exhibit improved CO₂ adsorption capacity and CO₂/N₂ adsorption selectivity compared to Comparative Example 1.

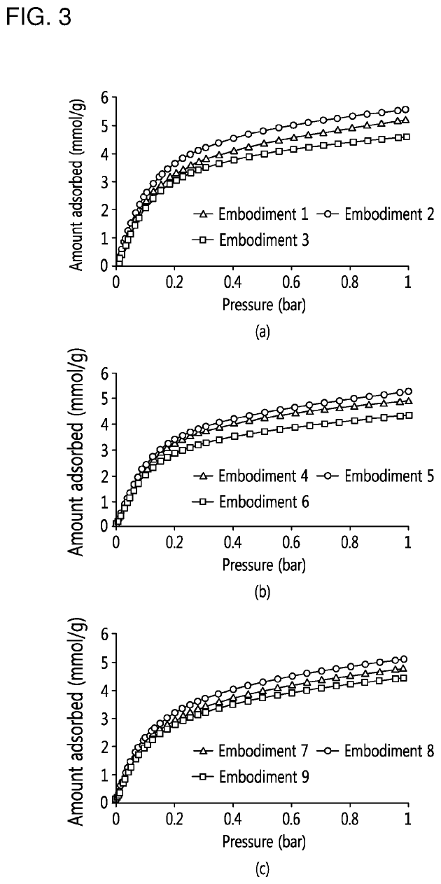

FIG. 3 illustrates a graph of the CO₂ adsorption capacity of the bimetal-organic framework prepared according to an embodiment of the present disclosure according to the additive ratio of a second metal. Specifically, (a) of FIG. 3 corresponds to Embodiments 1 to 3, (b) of FIG. 3 corresponds to Embodiments 4 to 6, and (c) of FIG. 3 corresponds to Embodiments 7 to 9.

Referring to FIG. 3, it can be seen that the highest CO₂ adsorption capacities are found in Embodiments 2, 5, and 8 (addition ratio Zn:X=7:2 (X=Mg, Mn, or Cu)). The CO₂ adsorption capacity of these bimetal-organic frameworks is attributed to the increase in surface area due to the dual introductions of the metals and the improved affinity for CO₂ due to the additional open metal sites.

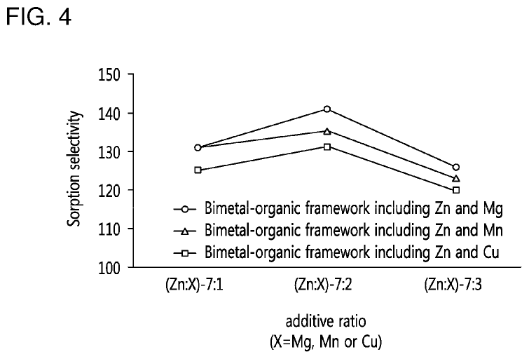

FIG. 4 illustrates a graph of the CO₂/N₂ adsorption selectivity with different weight percents of the second metal (Mg, Mn, or Cu) in a bimetal-organic framework prepared according to an embodiment of the present disclosure.

Referring to FIG. 4, it can be seen that the highest CO₂/N₂ adsorption selectivity is obtained in a bimetal-organic framework with a metal addition ratio of Zn:

$$X = 7 : 2 ( X = Mg , Mn , or Cu ) .$$

### Stability in Harsh Conditions

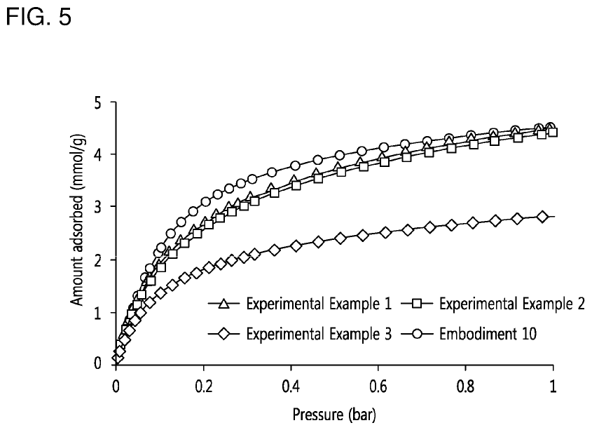

FIG. 5 illustrates a graph showing the CO₂ adsorption capacities of Embodiment 10 and Experimental Examples 1 to 3.

Referring to FIG. 5, it can be seen that bimetal-organic frameworks according to the present disclosure were not significantly changed even after exposure to humid air and NO₂ gas (i.e., acidic condition). It can be seen that the bimetal-organic frameworks of the present disclosure exhibit stable crystal structure, adsorption, and selectivity even when exposed to moisture, acid, etc.

The bimetal-organic frameworks proposed in the present disclosure include two metals, thereby allowing for improved CO₂ adsorption capacity and higher CO₂/N₂ adsorption selectivity than conventional metal-organic frameworks.

Moreover, the bimetal-organic frameworks according to the present disclosure exhibit a stable crystal structure, adsorption, and selectivity even when exposed to moisture, acid, etc., thereby being easily applied to the air environment industry.

The above description is merely an example of the technical idea of the present disclosure, and various modifications and variations can be made to those skilled in the art without departing from the essential characteristics of the present disclosure.

Therefore, the embodiments disclosed in the present disclosure are not intended to limit the technical idea of the present disclosure, but to explain, and the scope of the technical idea of the present disclosure is not limited by these embodiments. The protection scope of the present disclosure should be construed according to the claims below, and all technical ideas within the equivalent range should be construed as being included in the scope of the present disclosure.

### INDUSTRIAL APPLICABILITY

In the bimetal-organic frameworks according to the present disclosure, two metals are introduced, thereby having an improved CO₂ adsorption capacity and CO₂/N₂ adsorption selectivity compared to conventional metal-organic frameworks and exhibiting stable crystal structure, adsorption, and selectivity even when exposed to moisture, acid, etc.

What is claimed is:

1. A method for preparing a bimetal-organic framework, comprising:
preparing a first mixture by mixing a first metal precursor including zinc, a coordination compound of organic acid, and a substance including a counterion of the coordination compound in a solvent;
preparing a second mixture by mixing a second metal precursor including at least one metal selected from a group of magnesium, manganese, and copper in the first mixture; and
irradiating microwave to the second mixture.

2. The method of claim 1,
wherein the organic acid is selected from a group of citric acid, pyridine dicarboxylic acid, methyl fumarate, dihydroxyterephthalic acid, hydroxyterephthalic acid, ammonium citrate, and combinations thereof.

3. The method of claim 1,
wherein the counterion is selected from a group of K⁺, Na⁺, Li⁺, H⁺, Rb⁺, Cs⁺, and combinations thereof.

4. The method of claim 1,
wherein the first metal precursor is included at 70 wt % with respect to 100 wt % of the bimetal-organic framework.

5. The method of claim 1,
wherein the second metal precursor is included at 10 wt % to 30 wt % with respect to 100 wt % of the bimetal-organic framework.

6. The method of claim 1,
wherein the first mixture includes Zn(CH₃COO)₂·2H₂O, C₆H₈O₇·H₂O, and KOH.

7. The method of claim 1,
wherein the solvent is selected from a group of water, ethanol, methanol, ethyl ether, toluene, acetone, isopropyl alcohol, benzene, xylene, N-methylpyrrolidone, tetrahydrofuran, nitrobenzene, N,N-dimethylformamide, dimethyl sulfoxide, diethyl carbonate, benzyl acetate, dimethyl glutarate, ethyl acetoacetate, isobutyl isobutanoate, isobutyl acetate, m-Cresol, and combinations thereof.

8. The method of claim 1,
wherein the irradiating of the microwave to the second mixture is conducted for 2 hours to 8 hours.

9. The method of claim 1,
wherein the microwave is irradiated with a power of 100 W to 300 W.

10. The method of claim 1,
wherein the irradiating of the microwave to the second mixture is conducted at a temperature of 50° C. to 150° C.

11. A bimetal-organic framework, comprising:
zinc; and
at least one metal selected from a group of magnesium, manganese, and copper,
wherein the bimetal-organic framework adsorbs carbon dioxide.

12. The bimetal-organic framework of claim 11,
wherein the bimetal-organic framework is UTSA-16 (Zn, Mg), UTSA-16 (Zn, Mn), or UTSA-16 (Zn, Cu).

13. The bimetal-organic framework of claim 11,
wherein CO₂/N₂ adsorption selectivity of the bimetal-organic framework is 120 to 150.

14. The bimetal-organic framework of claim 11,
wherein pore volume of the bimetal-organic framework is 0.9 cm³/g to 1.5 cm³/g.
